(19) United States
(12) Patent Application Publication
(10) Pub. No.: US 2024/0318764 A1
(43) Pub. Date: Sep. 26, 2024

(54) INSULATION PANEL, PREPARATION METHOD THEREFOR AND REFRIGERATOR

(71) Applicants: QINGDAO HAIER SPECIAL REFRIGERATION ELECTRIC APPLIANCE CO., LTD., Qingdao (CN); QINGDAO HAIER REFRIGERATOR CO., LTD, Qingdao (CN); HAIER SMART HOME CO., LTD., Qingdao (CN)

(72) Inventors: Zhanzhan LIU, Qingdao (CN); Haijuan WANG, Qingdao (CN); Xueli CHENG, Qingdao (CN)

(21) Appl. No.: 18/574,639

(22) PCT Filed: Jun. 23, 2022
(86) PCT No.: PCT/CN2022/100768

§ 371 Date: Dec. 27, 2023

(30) Foreign Application Priority Data
Jun. 28, 2021 (CN) 202110718600.1

(51) Int. Cl. F16L 59/065; F16L 59/04; F25D 23/06

(52) U.S. Cl. CPC F16L 59/065; F16L 59/04; F25D 23/065; F25D 2201/14

(57) ABSTRACT

An insulating panel includes a vacuum insulation panel and insulating material. The vacuum insulation panel includes a core material and a coating material, wherein the core material provides an annular groove on one side, the coating material envelops the core material, and a vacuum is formed between the core material and the coating material; the insulating material is arranged in the annular groove enveloped by the coating material, the insulating material is located on the same plane as the vacuum insulation panel, and the thermal resistance of the insulating material is higher than the thermal resistance of the coating material. The disclosed insulating panel reduce the heat transfer to the edges and inside of the vacuum insulation panel through the insulating material. This reduction lowers the “thermal bridging effect” at the edges of the vacuum insulation panel, thereby achieving effective thermal insulation.

### TECHNICAL FIELD

This invention relates to the field of refrigeration appliances, and in particular, to an insulating panel, preparation method, as well as a refrigerator with the insulating panel.

### BACKGROUND

Vacuum insulation panels, a type of vacuum insulation material, are composed of a core material and a vacuum protective layer. They effectively prevent heat transfer caused by air convection. Currently, the application of vacuum insulation panels in refrigerators involves directly affixing flat vacuum insulation panels to the relatively flat surface of the refrigerator's shell, followed by foam filling. However, to maintain the internal vacuum, vacuum insulation panels often use materials like aluminum foil or aluminum vapor deposition for the overlay material. Due to aluminum's high thermal conductivity, heat transfers directly from one side to the other through the overlay material, leading to the “thermal bridging effect” at the edges of the vacuum insulation panel, resulting in poor energy efficiency at the edges.

The existing technical solution involves adding a thin layer of insulation material between the vacuum insulation panel and the refrigerator shell during application. Since the size of the insulation material is smaller than that of the vacuum insulation panel, the edges of the vacuum insulation panel are suspended. During the foaming of polyurethane, the disorderliness of the foam material and the small thickness of the suspended space can lead to polyurethane not filling properly, resulting in voids and surface defects.

### SUMMARY

An object of the present invention is to provide an insulating panel and its preparation method, as well as a refrigerator with the insulating panel.

To achieve one of the above objects, an embodiment of the present invention provides an insulating panel, comprising a vacuum insulation panel and insulating material;
the vacuum insulation panel comprises a core material and a coating material, wherein the core material provides an annular groove on one side, the coating material envelops the core material, and a vacuum is formed between the core material and the coating material;
the insulating material is arranged in the annular groove enveloped by the coating material, the insulating material is located on the same plane as the vacuum insulation panel, and the thermal resistance of the insulating material is higher than the thermal resistance of the coating material.

As a further improvement of the present invention, the coating material is configured as aluminum foil or aluminum vapor deposition.

As a further improvement of the present invention, the core material comprises at least one of glass fiber, glass wool, and fumed silica.

As a further improvement of the present invention, the insulating material comprises at least one of expanded polystyrene, foamed polyurethane, expanded polyethylene, and expanded polypropylene.

As a further improvement of the present invention, the thickness of the annular groove is ½-⅔ of the thickness of the core material.

As a further improvement of the present invention, one side end surface of the annular groove is flush with the side end surface of the core material, so that the adhered end surface of the insulating material and the vacuum insulation panel are in the same plane.

As a further improvement of the present invention, an adsorbent is provided inside the core material.

To achieve one of the above objects, an embodiment of the present invention provides a refrigerator, comprising a shell and a liner, wherein the insulating panel and foamed polyurethane according to claim 1 are provided between the refrigerator shell and liner, with the surface of the insulating material being attached to the refrigerator shell.

To achieve one of the above objects, an embodiment of the present invention provides a method for preparing an insulating panel, wherein the method comprises the following steps: forming an annular groove on one side of the prepared core material; inserting the core material with the annular groove into a pre-fabricated coating material bag; vacuum extraction and heat sealing of the core material and coating material bag, obtaining a vacuum insulation panel with the annular groove; molding an insulating material according to the size of the annular groove, the thermal resistance of the insulating material is higher than the thermal resistance of the coating material; adhering the cut insulating material into the annular groove of the vacuum insulation panel, wherein the insulating material is in the same plane as the vacuum insulation panel.

As a further improvement of an embodiment of the present invention, the core material of the insulating panel is configured as an integrally formed, or configured as laminated after made into unit sizes.

Compared to existing technologies, the disclosed insulating panel, preparation method, and a refrigerator with the insulating panel, reduce the heat transfer to the edges and inside of the vacuum insulation panel through the insulating material. This reduction lowers the “thermal bridging effect” at the edges of the vacuum insulation panel, thereby achieving effective thermal insulation.

### BRIEF DESCRIPTION OF THE DRAWINGS

FIG. 1a longitudinal sectional view of a refrigerator in an embodiment of the invention;

FIG. 2 is a sectional view of the insulating panel in an embodiment of the invention;

FIG. 3 is a sectional view of the vacuum insulation panel in an embodiment of the invention;

FIG. 4 is a flow chart of the preparation method for the insulating panel in an embodiment of the invention.

### DETAILED DESCRIPTION

The present invention will be described in detail in conjunction with embodiments shown in the figures. However, the embodiments are not intended to limit the present invention. Structural, methodological or function variations made by those having ordinary skill in the art according to the embodiments are all included in the protection scope of the present invention.

It should be appreciated that terms indicating spatial relative positions such as “up”, “down”, “in” and “out” used in the text herein are intended to describe a relationship of one unit or feature shown in figures relative to another unit or feature for an easy description purpose. The terms indicating spatial relative positions may be intended to include different orientations besides the orientations shown in the figures in use or operation of the device.

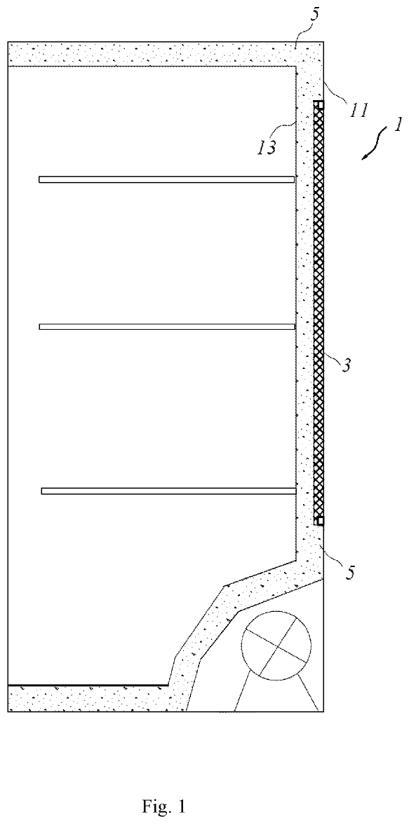

As shown in FIG. 1, an embodiment of the invention provides a refrigerator 1, comprising a shell 11 and a liner 13, with an insulating panel 3 and foamed polyurethane 5 set between the shell 11 and the liner 13, and the surface of the insulating material 3 being attached to the shell 11.

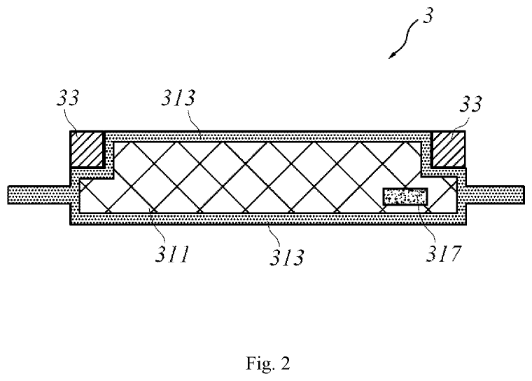

As shown in FIG. 2, an embodiment of the invention provides an insulating panel 3, comprising a vacuum insulation panel 31 and insulating material 33.

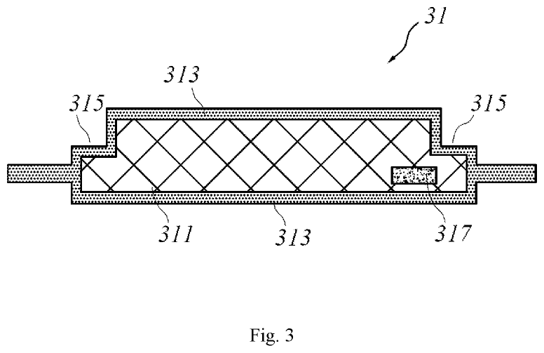

As shown in FIG. 3, the vacuum insulation panel 31 comprises a core material 311 and a coating material 313, the core material 311 provides an annular groove 315 on one side, and the coating material 313 envelops the core material 311, and a vacuum is formed between the core material 311 and the coating material 313.

In this embodiment, the core material 311 comprises at least one of glass fiber, glass wool, and fumed silica; the coating material 313 is configured as aluminum foil or aluminum vapor deposition that can block external gases; the insulating material 33 comprises at least one of expanded polystyrene, foamed polyurethane, expanded polyethylene, and expanded polypropylene.

Further, an adsorbent 317 is provided inside the core material 311, which used for absorbing gases escaping from the core material 311, further maintaining the vacuum inside the vacuum insulation panel 31.

In this embodiment, the core material 311 provides an annular groove 315 on one side, and the coating material 313 is a flexible material like aluminum foil or aluminum vapor deposition, it is understandable that the vacuum insulation panel 31 also has an annular groove 315 structure, which formed by vacuuming after the coating material 313 envelops the core material 311.

In this embodiment, when the external heat of the refrigerator 1 is transferred to the insulating panel 3 through the shell 11, since the insulating material 33 is placed in the annular groove 315 after the coating material 313 is enveloped, and the insulating material 33 is in the same plane as the vacuum insulation panel 31, the thermal resistance of the insulating material 33 is higher than the thermal resistance of the coating material 313; and the external heat of the refrigerator is transferred to the edge of the vacuum insulation panel 31 and the internal heat through the edge of the insulating material 33 is reduced, this reduction lowers the “thermal bridging effect” at the edges of the vacuum insulation panel, also reducing the heat transferred to the inside of the refrigerator.

Additionally, in this embodiment, the top surface of the insulating material 33 and the vacuum insulation panel 31 are in the same plane, making the insulating panel 3 have a flat surface, that is convenient for attachment to applications like the refrigerator shell.

In this embodiment, the thickness of the annular groove 315 can be ½-⅔ of the thickness of the core material 311. The annular groove 315 can be positioned near the edge of the core material 311. Further, the annular groove 315 can be positioned such that one side end face is flush with the side end face of the core material 311. Since the insulating material 33 is placed in the annular groove 315 after the coating material 313 is enveloped, the end face of the adhered insulating material 33 and the end face of the vacuum insulation panel 31 are in the same plane, forming a rectangular cross-section for the insulating panel 3. With a rectangular cross-section, the path of heat transfer through the surface of the coating material 313 becomes longer, further reducing the heat transfer to the inside of the refrigerator, thus enhancing the thermal insulation effect of the insulating panel 3. Moreover, when the refrigerator shell 11 and liner 13 are filled with foamed polyurethane 5, the smooth and flat surface of the insulating panel 3 avoids the formation of narrow spaces where the foamed polyurethane cannot fill, preventing voids and surface defects.

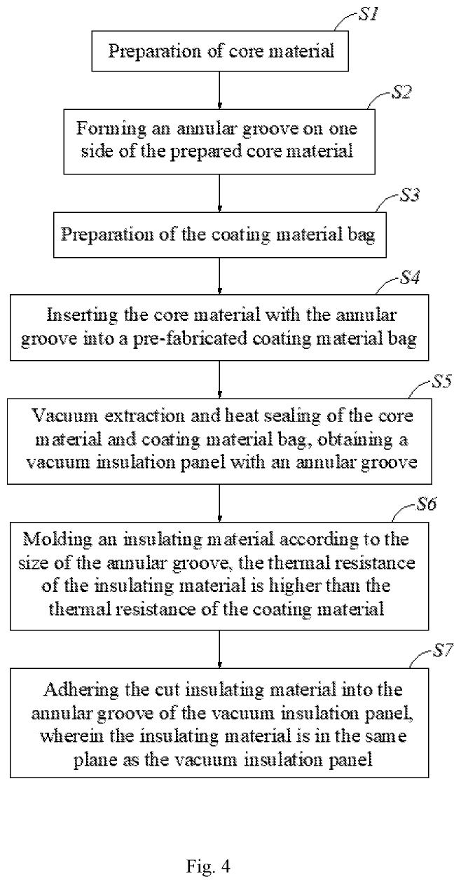

As shown in FIG. 4, an embodiment of this invention provides a method for preparing an insulating panel, comprising the following steps:

S1. Preparation of core material.

The core material of the insulating panel is configured as integrally formed, or configured as laminated after made into unit sizes. It can be understood that any production method for preparing a core material of a conventional shape can be used. Wherein, the core material may be at least one of glass fiber, glass wool and fumed silica.

S2. Forming an annular groove on one side of the prepared core material.

Any conventional processing method, such as milling, can be chosen for creating the annular groove. Specifically, the thickness of the annular groove can be selected as ½-⅔ of the thickness of the core material, and the position of the annular groove can be near the edge of the core material's end face.

S3. Preparation of the coating material bag.

The coating material is cut after multi-layer compounding to form a coating material bag. Specifically, the coating material can be materials like aluminum foil or aluminum vapor deposition that can block external gases.

S4. Inserting the core material with the annular groove into a pre-fabricated coating material bag.

S5. Vacuum extraction and heat sealing of the core material and coating material bag, obtaining a vacuum insulation panel with an annular groove.

After vacuum extraction of the core material and coating material bag, the coating material bag is heat-sealed, resulting in a vacuum insulation panel with the annular groove.

S6. Molding an insulating material according to the size of the annular groove, the thermal resistance of the insulating material is higher than the thermal resistance of the coating material.

Molds are prepared according to the size of the annular groove, and insulating material is prepared within the molds. The insulating material may be at least one of expanded polystyrene, foamed polyurethane, expanded polyethylene, and expanded polypropylene, or other materials with higher thermal resistance than the coating material.

S7 Adhering the cut insulating material into the annular groove of the vacuum insulation panel, wherein the insulating material is in the same plane as the vacuum insulation panel.

In this embodiment, the cut insulating material has a relatively flat and smooth surface and can be fixed in the annular groove of the vacuum insulation panel using double-sided tape, roller glue, etc.

The method for preparing the insulating panel provided by this invention is simple and easy to produce and process; meanwhile, the produced insulating panel achieves effective thermal insulation.

In this embodiment, while processing the annular groove on the surface of the core material, a groove for accommodating an adsorbent is also created inside the core material, and an adsorbent is placed in it. The adsorbent can absorb gases escaping from within the core material, further ensuring the vacuum inside the insulating panel. Further, the adsorbent can be a calcium oxide adsorbent.

It should be understood that although this specification describes the invention according to embodiments, not every embodiment contains an independent technical solution. This manner of description is solely for clarity. Those skilled in the art should consider this specification as a whole. Technical solutions from various embodiments can be appropriately combined to form other implementations understood by those skilled in the art.

1. An insulating panel, comprising a vacuum insulation panel and insulating material;
the vacuum insulation panel comprises a core material and a coating material, wherein the core material provides an annular groove on one side, the coating material envelops the core material, and a vacuum is formed between the core material and the coating material;
the insulating material is arranged in the annular groove enveloped by the coating material, the insulating material is located on the same plane as the vacuum insulation panel, and the thermal resistance of the insulating material is higher than the thermal resistance of the coating material.

2. The insulating panel according to claim 1, wherein the coating material is configured as aluminum foil or aluminum vapor deposition.

3. The insulating panel according to claim 1, wherein the core material comprises at least one of glass fiber, glass wool, and fumed silica.

4. The insulating panel according to claim 1, wherein the insulating material comprises at least one of expanded polystyrene, foamed polyurethane, expanded polyethylene, and expanded polypropylene.

5. The insulating panel according to claim 1, wherein the thickness of the annular groove is ½-⅔ of the thickness of the core material.

6. The insulating panel according to claim 1, wherein one side end surface of the annular groove is flush with the side end surface of the core material, so that the adhered end surface of the insulating material and the vacuum insulation panel are in the same plane.

7. The insulating panel according to claim 1, wherein an adsorbent is provided inside the core material.

8. A refrigerator, comprising a shell and a liner, wherein the insulating panel and foamed polyurethane according to claim 1 are provided between the refrigerator shell and liner, with the surface of the insulating material being attached to the refrigerator shell.

9. A method for preparing an insulating panel, wherein the method comprises the following steps: forming an annular groove on one side of the prepared core material; inserting the core material with the annular groove into a pre-fabricated coating material bag; vacuum extraction and heat sealing of the core material and coating material bag, obtaining a vacuum insulation panel with the annular groove; molding an insulating material according to the size of the annular groove, the thermal resistance of the insulating material is higher than the thermal resistance of the coating material; adhering the cut insulating material into the annular groove of the vacuum insulation panel, wherein the insulating material is in the same plane as the vacuum insulation panel.

10. The method for preparing an insulating panel according to claim 9, wherein the core material of the insulating panel is configured as an integrally formed, or configured as laminated after made into unit sizes.
